(19) United States
(12) Patent Application Publication
(10) Pub. No.: US 2024/0239283 A1
(43) Pub. Date: Jul. 18, 2024

(54) COMPUTER-IMPLEMENTED METHOD FOR CONTROLLING A PLURALITY OF COMPONENTS HAVING AN EFFECT ON AN INTERIOR OF A MOTOR VEHICLE

(71) Applicant: Dr. Ing. h.c. F. Porsche Aktiengesellschaft, Stuttgart (DE)

(72) Inventors: Dominik Klaiber, Leonberg (DE); Volker Sieber, Karlsbad (DE)

(21) Appl. No.: 18/413,561

(22) Filed: Jan. 16, 2024

(30) Foreign Application Priority Data
Jan. 17, 2023 (DE) 10 2023 100 944.3

(51) Int. Cl. B60R 16/037; B60J 3/04

(52) U.S. Cl. CPC B60R 16/037; B60J 3/04; B60N 2/0244

(57) ABSTRACT

A computer-implemented method is provided for controlling a plurality of components having a somatic, visual, acoustic and/or olfactory effect on a user in an interior of a motor vehicle. The method includes partitioning the interior into a plurality of different zones; and controlling the components as a function of the zones.

### CROSS-REFERENCE TO RELATED APPLICATION

This application claims priority on German Patent Application No 10 2023 100 944.3 filed Jan. 17, 2023, the entire disclosure of which is incorporated herein by reference.

### BACKGROUND

### Field of the Invention

The invention relates to a computer-implemented method for controlling a plurality of components having a somatic, optical, acoustic, and/or olfactory effect on a user in an interior of a motor vehicle.

### Related Art

Many components of a motor vehicle produce a visual, acoustic or olfactory effect. For example, a ventilation system without an olfactory element can have an acoustic and olfactory effect on the interior. The olfactory effect is caused in this case by odors outside the motor vehicle. However, this is not the main effect, but a side effect. A ventilation system without an olfactory element and individual components of such a ventilation system are thus not to be considered as components having an optical, acoustic or olfactory effect on the interior in terms of this description. On the other hand, an olfactory element installed in a ventilation system may be understood as a component having an olfactory effect on the interior of the motor vehicle within the meaning of this description. A prerequisite for this is that the olfactory effect of the olfactory element is in the foreground and is not a side effect.

From the prior art, it is known to select default settings for such components by means of a user input, such that a user does not need to make a setting for each component individually. The default settings are coordinated with each other and ensure increased comfort for the user. DE 10 2019 119 274 A1 discloses such a method and further discloses different interior scenarios based on different triggering events.

In contrast, an object of the present invention is to increase the experience value in the interior of the motor vehicle.

### SUMMARY OF THE INVENTION

A method in accordance with this disclosure divides the interior of the motor vehicles into a plurality of zones and controls components that have a somatic, visual, acoustic and/or olfactory effect on the user in the interior as a function of these zones. In particular, the components may be controlled in a coordinated manner. For example, a component that has a somatic effect on the user may be coordinated with the control of a component that has an acoustic effect on the user or vice versa.

The method of some embodiments enables different people to make their own comfort settings in the interior. For example, the needs of a passenger may be significantly different from those a driver. The driver needs to keep concentration high, but a passenger may make settings that help relaxation or even promote falling asleep.

According to one embodiment, the control may take place as a function of a control user input. In the context of this description, the control user input may be an input from a user that can be received, for example, via an input means such as a touchscreen. Thus, in this embodiment, a user may decide how the components in the different zones are to be controlled.

According to one embodiment, the control user input may be used to select a setting group from a collection of plural setting groups that control the components. Each setting group may include settings for each of the components. In this way, a user can easily call up coordinated settings when the setting groups comprise appropriately coordinated settings.

Different setting groups may be selected for different zones. For example, a first setting group may be selected for a first zone, whereas a second setting group may be selected for a second zone. The control may be performed in the first zone according to the first setting group and simultaneously in the second zone according to the second setting group.

The setting groups may be referred to as scenes. In addition to the scenes, events may be selected that have a greater effect on the user, for example over a short period of time according to their temporary state, than the scenes that are designed for long-term use, for example in relation to the deployment situation. For example, the events may be stimulating, invigorating, soothing, relaxing, or entertaining.

Control of the components may also be dependent on a state of the motor vehicle. The state can relate to a movement of the motor vehicle. For example, control may take place depending on whether the motor vehicle is traveling or stationary.

The collection also may be adapted to the state of the motor vehicle. For example, the user may be offered special first setting groups that may be selected only when the motor vehicle is stationary because they include a seating position of the user that is not permitted during the journey. Special second setting groups that may be used only in a traveling motor vehicle may also be offered to the user for selection.

In one embodiment, a preselection may be displayed to a user with plural setting groups from the collection. The preselection may be a subgroup of the collection. The preselection may depend on a user's state, a time, a time of day, a season, a location, a traffic situation, the weather, a user's appointment, and/or a past user behavior. The setting group may be selected from the preselection using the control user input.

In the context of this description, the user's state is understood to include the mental and/or physical state of the user. For example, the user's state may be determined via sensors. For example, using a camera filming the user's face, it may be determined whether the user is stressed, tense, relaxed or sleepy.

The location may be a current location of the vehicle or a destination to which a journey with the vehicle is planned, for example with a satellite navigation system.

The user's appointment may be read from a user's calendar that may be stored on a user's smartphone. This can be an appointment in the past or an appointment in the future. For example, if it is a relatively long appointment in the past, the preselection may include relaxing setting groups. If it is an appointment in the future the preselection may include setting groups that promote the user's alertness.

The preselection thus suggests to the user some setting groups that have been assessed as being particularly suitable. Thus, the decision for a particular setting group may be simplified for the user.

In some embodiments, each zone has one or more seats. The seats may be passenger seats. Thus, it is possible for one or more users to define their own zone.

In one embodiment, a first zone may comprise one or more front seats and a second zone may comprise one or more rear seats. In the context of this description, a front seat is understood to mean a seat that is arranged farther to the front in the longitudinal direction of the motor vehicle than other seats. Similarly, a rear seat is understood to mean a seat that is arranged farther to the back in the longitudinal direction than other seats. The longitudinal direction runs in the direction in which the motor vehicle is normally traveling without any steering angle.

According to one embodiment, the partitioning may be performed as a function of a partitioning user input. For example, this partitioning user input may be received by a user via an input means, such as a touchscreen. In this way, the user may decide how to divide the interior into the zones.

According to one embodiment of the invention, the components may comprise speakers, a music system, displays, light sources, window dimming, and/or a roof dimming. In particular, a music system is understood to mean a system connected to speakers that outputs electrical signals to the speakers, which are then converted into sound by the speakers. The use of roof dimming is particularly advantageous if the motor vehicle comprises a roof that is at least partially transparent.

The motor vehicle comprises an interior space and components configured to have a somatic, acoustic, visual, and/or olfactory effect on a user in the interior. A system is provided to perform the method described herein.

Further features and advantages of the invention will become apparent from the following description with reference to the appended illustration.

### BRIEF DESCRIPTION OF THE DRAWING

FIG. 1 is a schematic perspective view of an interior of a motor vehicle according to an embodiment of the invention.

### DETAILED DESCRIPTION

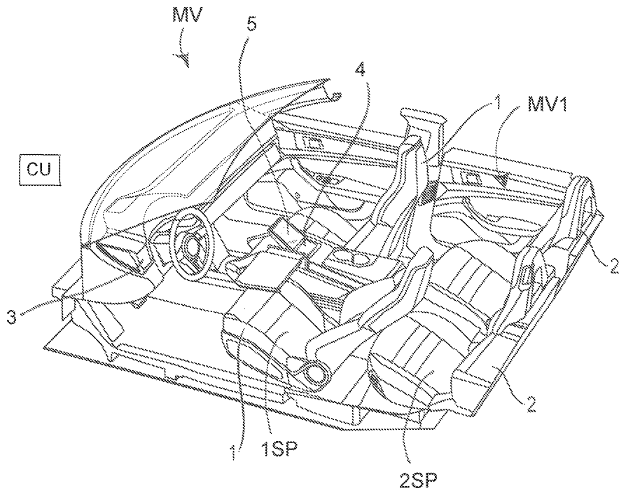

A motor vehicle in accordance with an embodiment of the invention is identified by MV in FIG. 1. The motor vehicle MV has an interior MVI with two front seats 1, two rear seats 2 and a plurality of components that have a somatic, visual, olfactory and acoustic effect on the interior MVI of the motor vehicle MV. A control unit CU of the motor vehicle MV controls various components of the motor vehicle MV that affect the somatic, visual, olfactory and acoustic effects in the interior MVI of the motor vehicle MV. The components may comprise activatable seat pads 1SP, 2SP incorporated into the seats 1, 2 respectively, massage and vibration equipment, speakers 3 connected to a music system 4, displays such as the center console display 5, different-colored light sources, fragrance sources, and window dimming to darken the windows. The control unit CU. “Control unit” is understood in connection with this disclosure to mean, for example, a machine or an electronic circuit. In particular, the control unit CU can be a master processor (central processing unit (CPU)), a microprocessor, or a microcontroller, for example an application-specific integrated circuit or a digital signal processor, optionally in combination with a memory unit for storing program instructions, etc. A processor also can mean a virtualized processor, a virtual machine, or a soft CPU. For example, it can also be a programmable processor equipped with configuration steps for carrying out the method or configured with configuration steps in such a way that the programmable processor realizes the features of the method, the system, or other aspects and/or partial aspects of the invention. In particular, the processor can include highly parallelized computing units and high-performance graphics modules. In connection with the invention, the control unit may include or connect with a “memory unit” such as a volatile memory in the form of a working memory (random access memory, RAM), or a permanent memory such as a hard drive or a data carrier or, for example, a replaceable memory module. However, the memory unit can also be a cloud-based storage solution. The control unit also may cooperate with an interface, such as the center consol display 5 with touch sensitive features. A similar display may be incorporated into positions that are accessible to passengers sitting in the rear seats 2, such as displays incorporated into the back faces of the front seats 1.

Different moods can be generated in the interior MVI via a control of the components, such as the interface defined by center consol display 5 or an interface that is accessible to passengers in the rear seats 2. The respective mood generated is in an experience for a person in the interior when the settings of the components are coordinated with one another. For example, this may mean that the color of the light sources is coordinated with the displays and/or that the music played via the music system matches the color of the light sources. By controlling the window dimming, the mood can be enhanced by blocking out visual stimuli from outside the interior. A controlled introduction of fragrance enhances the mood created.

The interior can be divided into two or more zones and for the components to be controlled as a function of the zones. A first zone may comprise the front seats 1 and a second zone may comprise the rear seats 2. Alternatively, each seat may define a separate zone. For example, the components for the first zone may be controlled in a manner perceived as comfortable for those persons sitting on the front seats 1, while the components for the second zone are controlled in a manner perceived as comfortable for those persons sitting on the rear seats 2. For example, relaxing music with subdued lighting can be set in the second zone so that persons in the rear seats 2 can relax. In the first zone, on the other hand, the settings can promote concentration.

It is also possible for seats 1 and 2 to be used to make the user's stay in the interior of the motor vehicle particularly comfortable. For example, a seat angle and/or a massage function may be adjusted to control the components.

1. A computer-implemented method for controlling components having a somatic, optical, acoustic, and/or olfactory effect on a user in an interior of a motor vehicle, the method comprising:
partitioning the interior into different zones; and
controlling the components as a function of the zones.

2. The method of claim 1, wherein the controlling is carried out a function of a control user input.

3. The method of claim 2, wherein the controlling comprises selecting a setting group from a collection with multiple setting groups used to control the components by means of the control user input, wherein each of the setting groups comprises settings for each of the components.

4. The method of claim 3, further comprising displaying to the user a preselection with a plurality of the setting groups from the collection, wherein the preselection depends on at least one of: a state of the user, a time, a time of day, a season, a location, weather, and a user appointment, and wherein the setting group is selected from the preselection by means of the control user input.

5. The method of claim 1, wherein the zones each comprise one or more seats.

6. The method of claim 5, wherein the zones comprise a first zone with one or more front seats (1) and a second zone with one or more rear seats (2).

7. The method of claim 1, wherein the partitioning is performed as a function of a partitioning user input.

8. The method of claim 1, characterized in that the components comprise at least one of seat actuators, speakers, a music system, displays, light sources, fragrance sources, window dimming and roof dimming.

9. A motor vehicle comprising:
an interior space defining plural separate zones;
components configured to have an acoustic, optical, and/or olfactory effect on a user in the interior; and
at least one control device that controls the components in the zones independently of one another.

10. The motor vehicle of claim 9, wherein the at least one control device comprises at least two control devices accessible respectively from front and rear seats of the motor vehicle.
